(19) United States
(12) Patent Application Publication
(10) Pub. No.: US 2005/0167456 A1
(43) Pub. Date: Aug. 4, 2005

(54) Protection arrangement for a big bag outlet spout

(76) Inventor: Avram Levi, Istanbul (TR)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/844,735

(22) Filed: May 13, 2004

(30) Foreign Application Priority Data
Jan. 29, 2004 (TR) 2004/00168

(51) Int. Cl. B67B 7/00; G01F 11/00; B65D 5/72; B65D 25/40; B65D 35/38

(52) U.S. Cl. 222/566

(57) ABSTRACT

A big bag comprising a base wall, a ceiling wall, and lateral walls formed and secured between the base and the ceiling walls for forming a closed formation, and further comprising a combined closure means provided on said base wall having a secondary closure part fastened to a primary closure part secured to said base wall for closing an outlet spout mounted to the base wall, and said outlet spout being discharging material therethrough; wherein said combined closure means (6) comprises at least a primary attaching means provided on said primary closure part fastened to said base, and at least a secondary attaching means provided on said secondary closure part, the secondary attaching means being capable of engaging to the primary attaching means.

### TECHNICAL FIELD

Present invention relates to a protection arrangement for an outlet spout of a big bag, commercially known as FIBCs, used to store and transport any kind of granules, powders or even semi-fluid materials, the outlet spout is mounted to the big bag for allowing any charged material therein to be unloaded to a desired location.

### BACKGROUND OF THE INVENTION

Big bags have become proper transporting and storing means for many years, because they provide many benefits with respect to a number of factors, particularly like their industrial-focused cost benefits, mechanical strengths, etc.

Although a large number of patent applications have been filed so far in relation to big bags, the present invention is focused on the outlet spout in such big bags, whereby a charged material is passed and thus emptied.

It has been preferred to properly secure, or protect the outlet spout of big bags in the prior art, to prevent any damage due to friction and material leakage therefrom, depending on the character of a material carried thereby.

By means of an extra lid element provided on the base region of such big bags to protect the outlet spout thereof, the base and so the outlet spout are covered and thus secured.

There are, however, two substantial disadvantages revealed in this kind of embodiments: first, the outlet spout is twisted like a swan-neck and then tied with a rope or a similar tying means like Velcro B-locks, fixlocks etc, before a lid is provided lower on said outlet spout. After this operation, the lid, which is generally sewed from one of its ends to the big bag base, is tied from its other end to tying holes opened on said base by means of an external component, such as a rope, etc. The figure showing this kind of embodiments is referred to as FIG. 1 in following pages and the disclosure with referenced part numbers are presented hereinbelow.

There are alternatives among other outlet spout closure embodiments with closure names like “rosettes” or “stars.” The aforementioned technical problems are not eliminated, however, by such “star” and “rosette” closure embodiments. That is to say, the spout closure is embodied with the use of an external component, and the spout is tied with the use of an external component as well, such as a rope, after itself is twisted in a swan-neck manner.

Therefore before the material contained in such a big bag is emptied, said tying components of said protection closures are loosened or untied and so the outlet spout reached and said spout—also tied with an external component—is untied and finally a charged material emptied.

The relevant prior art embodiments thus cause to two separate security or protection measures and so to excess material utilization and labor losses.

### BRIEF SUMMARY OF THE INVENTION

The objective of the present invention is to efficiently secure with low costs the spout of a big bag, whereby a charged material is unloaded.

The present invention provides a big bag comprising a base wall, a ceiling wall, and lateral walls formed and secured between the base and the ceiling walls to form a closed formation, and further comprising a combined closure means provided on said base wall comprising a secondary closure part fastened to a primary closure part secured to said base for closing an outlet spout mounted to the base wall, and said outlet spout discharging material being in the bag; characterized in that said combined closure means comprises at least a primary attaching means provided on said primary closure part fastened to said base and at least a secondary attaching means provided on said secondary closure part, the secondary attaching means being capable of engaging to the primary attaching means.

The primary and secondary attaching means ensuring the fastening of said closure means to said base according to the present invention are preferably a couple of velcro material pieces. The closure means under the present invention provides to roll the outlet spout by turning it upwards around a horizontal axis and so to wind it without the use of an external attaching means, in order to close the base with said closure means.

Therefore, Instead of closing the outlet spout first by folding to a so called swan neck and fixing by tying with rope, Velcro or similar devices like Fix-lock, B-Lock, through the arrangement according to the present invention, the outlet spout is rolled and remained rolled by means of the secondary closure part, which is simply a lid, made of preferably the same material as FIBC's during filling and transport.

So, the lid (secondary closure part) has basically two functions; firstly keep the outlet spout rolled as mentioned above and secondly protect the spout.

Once the big bag is attempted to be discharged, the lid is simply pulled down and is then the spout is unrolled immediately and material is discharged.

### BRIEF DESCRIPTION OF FIGURES

The present invention is to be considered together with the annexed figures described below in order to best understand the advantages of the present embodiment along with supplemental elements of this invention.

FIG. 1 shows the binding manner of an outlet spout closure means according to the prior art.

FIG. 2a is a perspective view of the closure means according to the present invention, as settled down to the base.

FIG. 2b is a perspective view of the closure means in a detached form from the base, and of the outlet spout in a rolled or wound form, all according to the present invention.

FIG. 2c is a perspective view of the closure means in a detached form from the base, and of the outlet spout in an unrolled or free form, all according to the present invention.

FIG. 3a is a front view of the closure means according to the present invention, as settled down to the base.

FIG. 3b is a front view of the closure means in a detached form from the base, and of the outlet spout in an unrolled or free form, all according to the present invention.

### DETAILED DESCRIPTION OF INVENTION

Big bags, as known, are embodied to have a base wall, a ceiling wall, and lateral walls formed and secured between the base and the ceiling walls to form a closed formation.

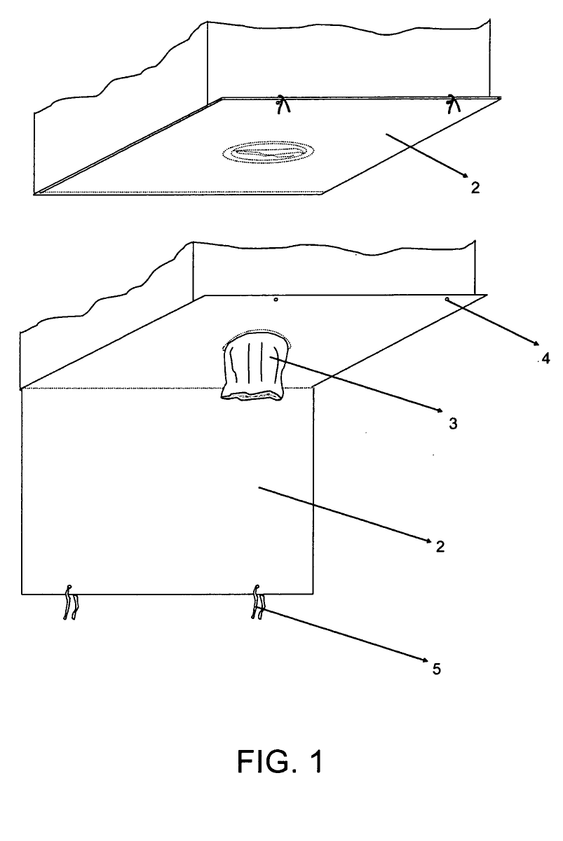

FIG. 1 shows the binding manner of a closure means of an outlet spout according to the prior art. Accordingly, a secondary closure part (2) in contact with a primary closure part (1) provided along the base of a big bag is tied by means of ropes (5), which are comprised in said secondary closure part (2) and are passed through the openings (4) embodied on said primary closure part. In a closed condition, the outlet spout is tied by means of another external element, such as a rope.

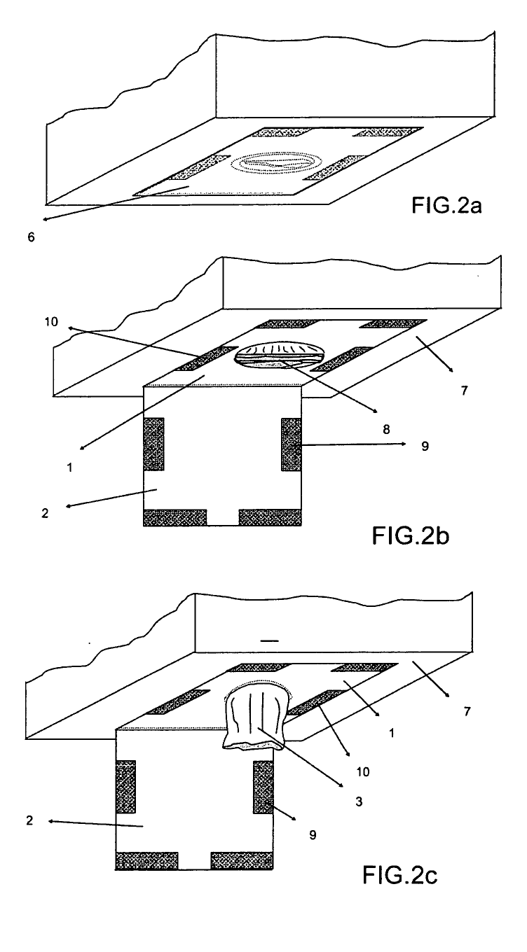

FIG. 2 gives a perspective view where said closure means under the present invention is in contact with the base. Accordingly, the combined closure means (6) comprises a primary closure part (1) fastened to the base of a big bag (7) and a secondary closure part (2) connected to the former (1).

The primary closure part (1) is preferably fastened only to a partial region of the base (7) comprising the outlet spout (3), instead of the entire base (7). The fastening between said primary closure part (1) and the base (4) is preferably carried out by means of sewing. The secondary closure part (2) is in contact with the primary closure part (1) and this contact is preferably obtained by folding the combined closure means (6) into two parts.

Primary attaching means (10) provided on the surface of said primary closure part (1) and secondary attaching means (9) provided on the secondary closure part (2) are engaged (fastened) in order to close the base (7) and thus the outlet spout (3).

Primary and secondary attaching means (10, 9) according to the present invention are preferably comprised of velcro material couples and such velcro material couples are fastened to said primary and secondary closure means (1, 2) preferably by means of sewing. Snap fastener or tying/attaching clip couples, in replace of such velcro material couples, are also covered under the present invention. A male velcro piece (10) of said velcro couples is fastened preferably to said primary closure part (1) and the female velcro piece (9) preferably to said secondary closure part (2); the position of the velcro pieces, however, can be changed, that is to say, the male velcro piece can be fastened to said secondary closure part (2) and the female velcro piece, to said primary closure part (1).

FIG. 2b gives a view where said primary closure part (1) becomes free, or opens, when the velcro piece of said primary closure part (1) is detached from the velcro piece on said secondary closure part. In this position, the outlet spout (3) is seen in a wound (8) form before an emptying operation is carried out. The outlet spout (3) is rolled upwards from the bottom in order to wind it. Winding and rolling of said outlet spout (3) does not require the use of any external binding or attaching means.

Such wound- or rolled-outlet spout (3) is freed, or unrolled, or opened in order to realize an emptying operation from said big bag.

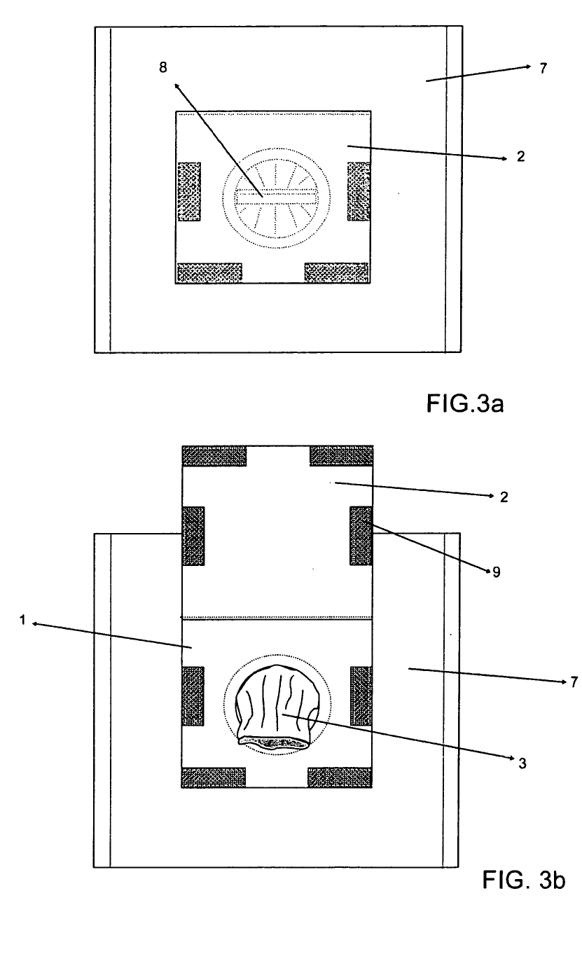

FIG. 3 group, is a front view of the group under FIG. 2, as described above.

The material used to manufacture said combined closure means (6), and thus said primary closure part (1) and said secondary closure part (2) making up said means (6) can be any textile material, but it is preferred to select such material from the big bag material with cost-benefit purposes.

1. A big bag comprising a base wall, a ceiling wall, and lateral walls formed and secured between the base and the ceiling walls for forming a closed formation, and further comprising a combined closure means provided on said base wall having a secondary closure part fastened to a primary closure part secured to said base wall for closing an outlet spout mounted to the base wall, and said outlet spout being discharging material therethrough; wherein said combined closure means (6) comprises at least a primary attaching means provided on said primary closure part fastened to said base, and at least a secondary attaching means provided on said secondary closure part, the secondary attaching means being capable of engaging to the primary attaching means.

2. A big bag according to claim 1, wherein said primary attaching means and said secondary attaching means are a couple of velcro material pieces, which can be engaged to each other.

3. A big bag according to claim 1, wherein said primary attaching means and said secondary attaching means are a couple of snap fasteners, which can be engaged to each other.

4. A big bag according to claim 1, wherein said primary attaching means and said secondary attaching means are a couple of tying clips, which can be engaged to each other.

5. A big bag according to claim 1, wherein said secondary closure part is closed on to said primary closure part after said outlet spout is rolled and remained rolled by means of the secondary closure part without using an additional attaching element.

6. A big bag according to claim 1, wherein said primary closure part is secured to said base so as to occupy a partial region comprising said outlet spout (3).
